(19) United States
(12) Patent Application Publication
(10) Pub. No.: US 2016/0208961 A1
(43) Pub. Date: Jul. 21, 2016

(54) A FLEXIBLE PIPE

(71) Applicant: NATIONAL OILWELL VARCO DENMARK I/S, Brondby (DK)

(72) Inventors: Kristian Glejbol, Glostrup (DK); Jan Rytter, Svenstrup J (DK)

(21) Appl. No.: 14/914,300

(22) PCT Filed: Aug. 28, 2014
(86) PCT No.: PCT/DK2014/050255

§ 371 Date: Feb. 25, 2016

(30) Foreign Application Priority Data
Sep. 2, 2013 (DK) PA 2013 70491

(51) Int. Cl. F16L 11/08

(52) U.S. Cl. CPC F16L 11/082

(57) ABSTRACT

A flexible offshore pipe includes a plurality of layers forming an inner pipe structure that includes an innermost sealing sheath. A first and a second tensile armor layer each including helically wound elongate armor elements surround the inner pipe structure. The first and the second tensile armor layer each has a winding pitch length and are cross wound. The pipe includes unbonded length sections and holding length sections. The elongate armor elements of the first tensile armor layer in the unbonded length sections are unbonded to said inner pipe structure and in each holding length section at least one of the elongate armor elements of the first tensile armor layer is more restricted to displacement relative to said inner pipe structure than the elongate armor elements of the first tensile armor layer in the unbonded length sections.

### TECHNICAL FIELD

The invention relates to a flexible pipe in particular for offshore and subsea transportation of fluids like hydrocarbons, CO², water and mixtures hereof. The pipe is in particular suitable for use as a riser.

### BACKGROUND ART

Large quantities of flexible pipes are used within the oil industry, basically for offshore production, but frequently onshore as well. In particular for offshore production flexible pipes are in many cases the only solution. The connection between the fixed equipment placed on the seabed and the floating drilling or production units usually requires flexible pipes. There are basically two types of flexible pipes: “unbonded flexible pipe” as described in standard “Specification for Unbonded Flexible Pipe”, ANSI/API 17J, Third edition, July 2008 and “Recommended Practice for Flexible Pipe”, ANSI/API 17 B, fourth Edition, July 2008 and “bonded flexible pipe”; as described in API 17K “Specification for Bonded Flexible Pipe” Mar. 1, 2002 and “Recommended Practice for Flexible Pipe”, ANSI/API 17 B, fourth Edition.

The unbonded flexible pipe construction consists of separate unbonded polymeric and metallic layers, which allows relative movement between layers. In the bonded flexible pipes the steel reinforcement is integrated and bonded to a vulcanized elastomeric material. Both constructions are spoolable; the bonded construction is generally used in short lengths up to 30-40 m, but it is normally available up to a few hundred meters in single pieces, which optionally can be assembled with intermediate couplings.

An unbonded flexible pipe usually comprises an inner liner also often called an inner sealing sheath or an inner sheath, which is the innermost sealing sheath and which forms a barrier against the outflow of the fluid which is conveyed in the bore of the pipe, and one or more armoring layers. Often the pipe further comprises an outer protection layer which provides mechanical protection of the armor layers. The outer protection layer may be a sealing layer sealing against ingress of sea water. In certain unbonded flexible pipes one or more intermediate sealing layers are arranged between armor layers.

In general flexible pipes are expected to have a lifetime of 20 years in operation.

Examples of unbonded flexible pipes are e.g. disclosed in U.S. Pat. No. 6,978,806; U.S. Pat. No. 7,124,780; U.S. Pat. No. 6,769,454 and U.S. Pat. No. 6,363,974.

The term “sealing sheath” is herein used to designate a liquid impermeable layer, normally comprising or consisting of polymer. The term “inner sealing sheath” designates the innermost sealing sheath. The term “intermediate sealing sheath” means a sealing sheath which is not the inner sealing sheath and which comprises at least one additional layer on its outer side. The term “outer sealing sheath” means the outermost sealing sheath.

The armoring layers usually comprise or consist of one or more helically wound elongated armoring elements, where the individual armor layers are not bonded to each other directly or indirectly via other layers along the pipe. Thereby the pipe becomes bendable and sufficiently flexible to be rolled up for transportation.

A traditional prior art flexible unbonded pipe comprises from inside and outwards an optional carcass (sometimes also called an inner armor), an innermost sealing sheath, a pressure armor, a tensile armor and optionally an outer protection sheath for mechanical protection and/or for sealing against ingress of seawater in use. The pipe may comprise additional layers, such as anti-wear layers between armor layers, insulating layers, intermediate sealing layers and/or an anti-birdcage layer outside the outermost tensile layer to prevent the tensile armor layer from buckling.

The carcass has the purpose of protecting the innermost liner against from collapsing when subjected to compressive forces e.g. mechanical forces acting on the pipe or compressive fluids trying to squeeze the liner such as hydrostatic pressure. The carcass usually comprises helically wound and interlocked elongate armor elements. The innermost sealing sheath forms the innermost sealing sheath and defines the bore of the pipe.

The tensile armor is usually in form of a plurality of tensile armor layers which are usually pair-wise cross wound (wound with opposite winding direction). The tensile armor layers are normally composed of elongate armor elements which are helically wound with a relative low winding degree relative to the axis of the pipe—e.g. about 55 degrees or very often less. The tensile armor has the purpose of providing the pipe with strength in its length direction and preventing undesired elongation of the pipe while still maintaining high flexibility.

In many applications, in particular where high flexibility and high pressure resistance are desired, unbonded flexible pipes are preferred over bonded pipes where the reinforcing wires are embedded in a polymer matrix. Bonded pipes allow no or very little longitudinal or axial motion of the armoring wires and thereby restrict the flexibility of the pipe to a very low level.

For example it can be mentioned that unbonded flexible pipes are highly suitable for deep water, high pressure and dynamic applications. However, during the laying of the unbonded flexible pipe or when in use the pipe may be subjected to shock impact acting in the lengthwise direction of the pipe as well as lengthwise stretch and or compression.

Such impacts often result in radial deformations such as buckling of the tensile-armor wires of the pipe. As mentioned above, it is well known to apply anti-birdcage layer outside the outermost tensile layer to prevent the tensile armor layer from buckling. However, this solution is not sufficient where the pipe is subjected to dynamic stress e.g. during service of a pipe connecting a subsea installation e.g. at the sea bottom to a surface installation e.g. a floating unit, and furthermore such anti-birdcage layer often results in an undesired decrease in flexibility of the pipe because the anti-birdcage layer normally is in form of a tightly wound hooping strip. Further, there is still a high risk of axial displacement of the wires, such that the distribution of winding of wires will be highly uneven along the length of the pipe.

EP1459003 discloses a method to limit transverse displacements of the reinforcing wires wherein the wires are wound very tightly such that the play separating two contiguous elements, measured on the circumference, is less than 3%. Such winding, however, is very difficult to perform and will likely not be possible on an industrial scale, furthermore such tight winding may further increase the risk of buckling of the tensile-armor wires upon axial compression of the pipe.

### DISCLOSURE OF INVENTION

The object of the invention is to provide a flexible pipe for offshore transportation of fluids where the pipe has a high resistance against buckling when subjected to dynamic stress while simultaneously the pipe has a high flexibility.

This and other objects have been solved by the invention as defined in the claims and as described herein below.

It has been found that the invention and embodiments thereof have a number of additional advantages which will be clear to the skilled person from the following description.

According to the invention it has been found that by locally restricting displacement of the tensile armor layer relative to an underlying inner pipe structure while maintaining an unbonded configuration of the tensile armor layer between the local restrictions, any risks of buckling can be kept at a minimum while simultaneously the flexibility remains very high.

The flexible offshore pipe of the invention is in particularly suitable for the transportation of petrochemical fluids. The pipe comprises a plurality of layers comprising an inner pipe structure and a first and a second tensile armor layers surrounding the inner pipe structure. The inner pipe structure comprises at least an innermost sealing sheath defining a bore and a center axis defining a length of the pipe. As it will be clear from the following the inner pipe structure may comprise additional layers, such as a pressure armor layer and/or an insulation layer.

The first and the second tensile armor layers each comprising a plurality of helically wound elongate armor elements and the layers are cross wound with respect to each other. Each of the first and the second tensile armor layers has a winding pitch length. The winding pitch length is the length of the pipe—i.e. determined along the length of the pipe—which it takes one of the elongate armor elements of the tensile armor layer in question to reach one whole winding around the inner pipe structure when the pipe is in un-loaded condition. The un-loaded condition of the pipe includes that the pipe is placed substantially horizontally on a horizontal support (e.g. a floor or on the ground).

In all determinations of size and structure the pipe should be in un-loaded condition unless specifically stated otherwise.

The first tensile armor layer designates a tensile armor layer arranged inside the second tensile armor layer. Preferably, the second tensile armor layer is applied directly onto the first tensile armor layer optionally with a tape layer in between, and optionally with fixing means in between in the holding length sections.

The term “in radial direction outwards” as well as “radially outwards” means a direction from the axis of the pipe and radially outwards. The term “in radial direction inwards” as well as “radially inwards” means a direction opposite to radially outwards. The term “in radial direction” as well as “radially” means either radially outwards or radially inwards

The terms “inside” and “outside” a layer of the pipe are used to designate the relative distance to the axis of the pipe, such that “inside a layer” means the area encircled by the layer i.e. with a shorter axial distance than the layer and “outside a layer” means the area not encircled by the layer and not contained by the layer, i.e. with a shorter axial distance than the layer.

The term “substantially” should herein be taken to mean that ordinary product variances and tolerances are comprised.

The term “cross-wound layers” means that the layers comprise wound elongate elements that are wound in opposite direction relatively to the longitudinal axis of the pipe where the angle to the longitudinal axis can be equal to or different from each other.

The term “winding direction” means winding direction relatively to the longitudinal axis of the unbonded flexible pipe unless otherwise specified.

Filaments are continuously single fiber (also called monofilament).

The phrase “continuous” as used herein in connection with fibers, filaments, strands, yarns or rovings means that the fibers, filaments, strands, yarns or rovings means that they generally have a significant length but should not be understood to mean that the length is perpetual or infinite. Continuous fibers, such as continuous filaments, strands, yarns or rovings preferably have a length of at least about 10 m, preferably at least about 100 m, more preferably at least about 1000 m.

The term “strand” is used to designate an untwisted bundle of filaments.

The term “yarn” is used to designate a twisted or woven bundle of filaments and/or cut fibers. Yarn includes threads and ropes. The yarn may be a primary yarn made directly from filaments and/or cut fibers, or a secondary yarn made from yarns and/or cords. Secondary yarns are also referred to as cords.

The term “roving” is used to designate an untwisted bundle of strands or yarns. A roving includes a strand of more than two filaments. A non-twisted bundle of more than two filaments is accordingly both a strand and a roving.

Filament yarn consists of filament fibers (very long continuous fibers) either twisted together or only grouped together. Thicker monofilaments are typically used for industrial purposes rather than fabric production or decoration.

It should be emphasized that the term “comprises/comprising” when used herein is to be interpreted as an open term, i.e. it should be taken to specify the presence of specifically stated feature(s), such as element(s), unit(s), integer(s), step(s) component(s) and combination(s) thereof, but does not preclude the presence or addition of one or more other stated features.

The term ‘seabed’ is generally used to demote the subsea floor.

The lengths of the holding length sections and lengths of the unbonded length sections of the elongate armor elements are determined along the length of the elongate armor elements in question when the pipe is in un-loaded condition.

The pipe comprises a plurality of unbonded length sections and a plurality of holding length sections. In the unbonded length sections the elongate armor elements of at least the first tensile armor layer are unbonded to the inner pipe structure. In each holding length section at least one of the elongate armor elements of the first tensile armor layer is more restricted to displacement relative to the inner pipe structure than the same elongate armor elements of the first tensile armor layer in the unbonded length sections. Further, the total length of a holding length section and an adjacent unbonded length section is at least about the winding pitch length of the first tensile armor layer.

In an embodiment, when the flexible pipe is bent, e.g. to about 50% of its minimum bend radius (MBR), in a unbonded length section, the elongate armor elements of the first tensile armor layer in this unbonded length sections will be displaced with respect to the inner pipe structure e.g. by sliding. When repeating the bend where the flexible pipe has a holding length section the displacement of the one or more elongate armor elements in this section of at least the first tensile armor layer with respect to the inner pipe structure will be more restricted, and therefore the force required to perform the bend will be higher.

The MBR is determined by ISO 13628-2 or by ISO 13628-10 where the pipe has no pressure tensile armor layer.

The unbonded length sections provide the pipe with a very high flexibility which is comparable to or even as high as for common unbonded flexible pipes without bonds or high friction areas between the first tensile armor layer and the inner pipe structure, whereas the holding length sections ensure a high resistance against buckling or undesired displacement of the tensile armor wires. In an embodiment the flexible pipe is as an unbonded flexible pipe consisting of essentially unbonded layers with the exception that the at least one elongate armor element of the first tensile armor layer in each holding section of the pipe is fixed to, squeezed against and/or has a higher displacement friction to the inner pipe structure than the elongate armor elements have in the unbonded length sections of the pipe.

In this connection it should be observed that the term ‘bonded’ means interfacial bonded in substantially the entire interface between the bonded layers.

In an embodiment a plurality, such as at least half or more preferably all of the elongate armor elements of the first tensile armor layer are more restricted to displacement relative to the inner pipe structure in the holding length sections than the elongate armor elements of the first tensile armor layer in the unbonded length sections. Generally, it is much simpler to provide the increased restriction to displacement relative to the innermost sealing sheath in holding length sections by providing that all the elongate armor elements of the first tensile armor layer are subjected to the increased restriction.

In an embodiment the at least one elongate armor element of the first tensile armor layer in each holding section of the pipe is fixed to, squeezed against and/or has a higher displacement friction to the inner pipe structure than the elongate armor elements have in the unbonded length sections of the pipe. Thereby it can in a simple way result in that the at least one of the elongate armor elements of the first tensile armor layer in each holding section more restricted to displacement relative to the inner pipe structure than the elongate armor elements of the unbonded length sections.

In an embodiment the at least one elongate armor element of the first tensile armor layer in at least one, preferably in a plurality, such as in each holding length section of the pipe is fixed to the inner pipe structure. The fixing in one or more holding length section(s) is advantageously provided by a fixing material by a welding and/or a chemical bonding. The fixing material can for example be a polymeric adhesive e.g. epoxy or thermoplastic material which is acting upon heating.

In an embodiment a plurality, preferably all of the elongate armor elements of the first tensile armor layer in at least one, preferably in a plurality, such as in each holding length section of the pipe is fixed to the inner pipe structure. In this embodiment the fixing is preferably provided by arranging a fixing material between the first tensile armor layer and the inner pipe structure in the holding length section. The fixing material can be applied in a simple way in an annular formation around the inner pipe structure prior to applying the elongate armor elements of the first tensile armor layer.

In an embodiment the fixing material is a thermoplastic material and the fixing comprises subjecting at least the holding length sections of the pipe to heat.

In an embodiment the fixing material is a cross-linkable, such as PE or rubber optionally comprising a radical generating additive and the fixing comprises subjecting at least the holding length sections to cross-linking activating e.g. in form of heat and/or irradiation.

In an embodiment the fixing material is an adhesive.

In an embodiment the at least one elongate armor element of the first tensile armor layer in at least one, preferably in a plurality, such as in each holding section of the pipe is squeezed against the inner pipe structure. The term “squeezed” should be interpreted to include any kind of pressure acting in radial direction on the first tensile armor layer.

Advantageously the at least one elongate armor element of the first tensile armor layer is squeezed against the inner pipe structure by applying a squeezing pressure radially against the first tensile armor layer in the holding length section, preferably by applying the squeezing pressure radially inwards.

In an embodiment the squeezing pressure is caused by at least one squeezing element arranged to at least partly surround the first tensile armor layer.

The at least one squeezing element is advantageously in form of an annular clamping structure arranged to press the first tensile armor layer against the inner pipe structure. In an embodiment the annular clamping structure is arranged directly outside the first tensile armor layer. In an embodiment the annular clamping structure is arranged outside a tape layer placed upon the first tensile armor layer. In an embodiment the annular clamping structure is arranged directly outside the second tensile armor layer. In an embodiment the annular clamping structure is arranged outside a tape layer placed upon the second tensile armor layer. In an embodiment the annular clamping structure is arranged outside an outer protection layer of the pipe.

The annular clamping structure is advantageously in form of wound strips, strands, yarns, cords and/or filaments. More preferably the annular clamping structure is of composite strips comprising fiber reinforced polymer. The fiber used is advantageously fibers selected from basalt fibers, polypropylene fibers, carbon fibers, glass fibers, aramid fibers, steel fibers, polyethylene fibers, mineral fibers and/or mixtures comprising at least one of the foregoing fibers.

The composite strips preferably comprise at least about least 10% by weight of fibers, such as from about 20% to about 90% by weight of fibers.

Glass fibers are very advantageous to use because they are very strong and relative cheap and simple to handle.

In an embodiment the composite strips are made of Kevlar®.

Wound strips, strands, yarns, cords and/or filaments can be applied by winding in a plurality of windings with a desired tightness and with a fixing to itself at desired position to hold the final annular clamping structure in position and such that it provides the desired squeezing without simultaneously collapsing the pipe. Advantageously the pipe comprises a carcass to alleviate the squeezing pressure.

Generally it is desired that the annular clamping structures are exclusively arranged in the holding length sections.

In an embodiment the at least one elongate armor element of the first tensile armor layer in at least one, preferably in a plurality such as in each holding length section of the pipe has a higher displacement friction to the inner pipe structure than the elongate armor elements have in the unbonded length sections of the pipe, thereby causing the at least one of the elongate armor elements of the first tensile armor layer in each holding section to be more restricted to displacement relative to the inner pipe structure than the elongate armor elements of the unbonded length sections.

By the term “friction” as used herein in is meant static friction.

In an embodiment the higher displacement friction is provided by providing the at least one elongate armor element of the first tensile armor layer with a higher roughness than in the unbonded length sections and or by providing the inner pipe structure with a higher outermost surface roughness in the holding length sections than in the unbonded length sections. The higher roughness can for example be provided by providing cavities and/or recesses in the elongate armor elements of the tensile armor layer.

In an embodiment the higher displacement friction is caused by providing a friction element between the first tensile armor layer and the inner pipe structure in the holding length section. The friction element is advantageously made of a polymer material, such as a polymer material having a hardness which is less than an outermost surface hardness of inner pipe structure. The friction element can for example be applied directly onto the outer surface of the inner pipe structure in the holding length sections e.g. as annular friction elements. In an embodiment the friction element is of a polymeric elastomer material having a hardness of 90 Shore A or less, such as a material having a hardness of from about 60 to about 80 Shore A. Advantageously the friction element is of rubber.

Shore A is generally determined according to ISO 7619.

In an embodiment the friction element is an annular friction element arranged directly between the inner pipe structure and the first tensile armor layer.

Generally it is desired that the friction elements are exclusively arranged in the holding length sections. However, in an embodiment the invention also comprises having friction elements in the unbonded length sections provided that at least one of the elongate armor elements of the first tensile armor layer is more restricted to displacement relative to the inner pipe structure than the same elongate armor elements of the first tensile armor layer in the unbonded length sections, for example where these friction elements in the unbonded length sections generate less displacement friction than the friction elements in the holding length sections.

The inner pipe structure is defined as the structure of the pipe inside the tensile armor layers.

In an embodiment the inner pipe structure has an outermost layer provided by a sealing sheath which advantageously has a thickness of at least about 4 mm. The at least one elongate armor element of the first tensile armor layer in at least one, preferably in a plurality, such as in each holding section of the pipe is fixed to, squeezed against and/or or has a higher displacement friction to the outermost layer of the inner pipe structure than the same elongate armor elements have in the unbonded length sections of the pipe. Advantageously the sealing sheath is the innermost sealing sheath. Alternatively the sealing sheath is an intermediate sealing sheath.

In an embodiment the inner pipe structure has an outermost layer provided by a tape, such as an anti-wear tape and a strength imparting layer below the tape. The at least one elongate armor element of the first tensile armor layer in at least one, preferably in a plurality, such as in each holding section of the pipe is fixed to, squeezed against and/or has a higher displacement friction to the strength imparting layer of the inner pipe structure than the elongate armor elements have in the unbonded length sections of the pipe.

The strength imparting layer is e.g. the innermost sealing sheath or a pressure armor layer arranged outside the innermost sealing sheath.

In an embodiment the strength imparting layer is an insulation layer with sufficient strength to not be damaged by the forces exerted from the tensile armor layers in the holding length sections.

In an embodiment the elongate armor elements are fixed to the strength imparting layer using a fixing material which partly penetrates the strength imparting layer to an underlying layer for further anchoring the elongate armor elements of at least the first tensile armor layer to the inner pipe structure in the holding length sections.

Advantageously the inner pipe structure comprises a pressure armor layer arranged outside the innermost sealing sheath. The pressure armor layer has the function of reinforcing the pipe against high pressure in the bore of the pipe. Where the pipe is for deep water applications and/or for use as a riser pipe, such pressure armor layer is particularly advantageous. The pressure armor can have any structure and composition e.g. such as it is generally known in the art. In an embodiment the pressure armor layer comprises at least one helically wound elongate armor element, preferably wound with a winding degree relative to the center axis of about 70° or more, such as about 80° or more.

In an embodiment the pressure armor layer comprises at least one helically wound elongate armor elements of metal e.g. as disclosed in the standard “Recommended Practice for Flexible Pipe”, ANSI/API 17 B, fourth Edition, July 2008, and the standard “Specification for Unbonded Flexible Pipe”, ANSI/API 17J, Third edition, July 2008.

In an embodiment the pressure armor layer comprises at least one helically wound elongate armor element of fiber reinforced polymer e.g. as described in PCT/DK2013/050096.

In an embodiment the inner pipe structure has an outermost layer provided by the pressure armor layer and the at least one elongate armor element of the first tensile armor layer in at least one, preferably in a plurality, such as in each holding section of the pipe is fixed to, squeezed against and/or has a higher displacement friction to the pressure armor layer of the inner pipe structure than the elongate armor elements have in the unbonded length sections of the pipe. Due to the strength of the pressure armor layer, any displacement forced transferred from the tensile armor layer(s) to the pressure armor layer will be effectively absorbed by the pressure armor layer.

In an embodiment wherein the at least one elongate armor element of the first tensile armor layer in the holding section of the pipe is squeezed against the inner pipe structure by applying a squeezing pressure in form of at least one annular clamping structure arranged to press the first tensile armor layer against the inner pipe structure, it is advantageous that the annular clamping structure has an axial stiffness which is less than the axial stiffness of the armor elements of the pressure armor layer.

The axial stiffness is the resistance of relatively the elongate armor element and the annular structure element to be elongated by an axial force and is determined by A*E, where A is the cross sectional area of respectively the elongate armor (taken perpendicularly to the elongate armor element) element and the annular structure (taken perpendicularly to the annular extension).

By providing that the annular clamping structure has an axial stiffness which is less than the axial stiffness of the armor elements of the pressure armor layer, the flexibility of the pipe will be almost as it would have been without the holding length sections.

Preferably the inner pipe structure further comprises a carcass arranged inside the innermost sealing sheath. The function of the carcass is in particular to reinforce the pipe against collapse caused by pressures acting radially inwards, such as hydrostatic pressure.

The elongate armor elements of the tensile armor layers can be of any structure and any material such as it is known in the art e.g. as provided in the standard “Recommended Practice for Flexible Pipe”, ANSI/API 17 B, fourth Edition, July 2008, and the standard “Specification for Unbonded Flexible Pipe”, ANSI/API 17J, Third edition, July 2008.

In an embodiment at least some of the elongate armor elements of the tensile armor layer are of metal, such as steel.

In an embodiment at least some of the elongate armor elements of the tensile armor layer are of composite material, preferably comprising fiber reinforced polymer.

Advantageously at least one, such as most of and preferably all of the elongate armor elements are of composite material e.g. as described in U.S. Pat. No. 6,165,586, WO 01/51839 and/or U.S. Pat. No. 7,842,149.

In an embodiment the elongate armor elements of the tensile armor layer(s) are as described in PCT/DK2013/050063.

In an embodiment the elongate armor elements of the tensile armor layers are wound with an angle to the center axis of from about 20° to about 70°, such as from about 30° to about 60°, such as from about 35° to about 55°.

Generally it has been found that the present invention allows the winding angle for the elongate armor elements of the tensile armor layers to be lower than what is usually recommended because the present invention reduces or even eliminate any risks of birdcageing of the elongate armor elements and buckling of the pipe. In an embodiment the elongate armor elements of at least the first tensile armor layers are wound with an angle to the center axis of about 40° or less.

In an embodiment the elongate armor elements of the cross wound first tensile armor layer and second tensile armor layer have same winding angle to the center axis.

Thereby the winding pitch of the cross wound first tensile armor layer and second tensile armor layer have substantially same pitch length. The pitch length of an armor layer of helically wound elongate armor elements is the length section of the pipe it takes for one whole winding of an elongate armor element.

In an embodiment the elongate armor elements of the first tensile armor layer have a winding angle which differs from the winding angle of the elongate armor elements of the second tensile armor layer. The pitch length of the first tensile armor layer will in this embodiment normally be different from the pitch length of the second tensile armor layer.

Generally it is desired that the pitch length of the second tensile armor layer does not differ more than about 15%, preferably less than about 10% from the pitch length of the first tensile armor layer.

In an embodiment the elongate armor elements of the second tensile armor layer in the unbonded length sections are unbonded to the inner pipe structure, and the first tensile armor layer and in each holding length section the elongate armor elements of the second tensile armor layer are fixed to or squeezed against the first tensile armor layer. Thereby displacement forces from both the first and the second tensile armor layers can be transferred to the inner pipe structure.

Advantageously, the elongate armor elements of the second tensile armor layer is fixed to the elongate armor elements of the first tensile armor layer in the holding length sections and is not fixed to the elongate armor elements of the first tensile armor layer in the unbonded length sections.

The fixing of the elongate armor elements of the second tensile armor layer to the elongate armor elements of the first tensile armor layer is preferably provided by arranging a fixing material between the first tensile armor layer and the second tensile armor layer inner pipe structure in the holding length section.

In an embodiment the elongate armor elements of the second tensile armor layer are squeezed against the first tensile armor layer in the holding length sections by applying a squeezing pressure against the first tensile armor layer in the holding length section, preferably the squeezing pressure simultaneously cause the elongate armor element of the first tensile armor layer to be squeezed against the inner pipe structure. The squeezing pressure advantageously caused by at least one annular clamping structure arranged to press the second and the first tensile armor layer against the inner pipe structure as described above.

Advantageously the pipe comprises an outer protecting layer. The outer protecting layer is in an embodiment sealing against ingress of water when the pipe is subsea. In an embodiment the outer protecting layer is liquid pervious and allow sea water to flow into contact with the tensile armor layer(s).

The outer protecting layer advantageously comprises markings indicating lengthwise positions of pipe holding length sections and/or of pipe unbonded length sections. It has been found that the holding length sections provide areas along the pipe which are more suited than the unbonded length sections as gripping areas for the equipment used when the pipe is deployed. By marking the various sections the pipe thereby further will have an increased strength for the deployment equipment.

In principle the holding length sections need not be long in order to fulfill their purpose. It is therefore advantageous to keep the holding length sections relatively short. In an embodiment the length of the holding length sections is up to about 2 m. The preferred length of the holding length sections is from about ½ cm to about 1 m, such as from about 1 cm to about 0.5 m.

Generally it is desired that the holding length sections have just about the sufficient length to provide an adequate and lasting connection for transferring displacement forces from the first and optionally the second tensile armor layer to the inner pipe structure.

Advantageously the length of the holding length sections is substantially equal to each other.

The unbonded length sections should on the other hand not be too short, since this may reduce the flexibility of the pipe.

Preferably the average length of the holding length sections is shorter than the average length of the unbonded length sections. In an embodiment the average length of the holding length sections is about 20% or less, such as about 10% or less, such as about 5% or less than the average length of the unbonded length sections.

In an embodiment most of the holding length sections the length thereof are shorter than the lengths of any adjacent unbonded length sections. Preferably the sum of the lengths of the holding length sections is less than about 20% of the total length of the pipe.

In an embodiment the holding length sections and the unbonded length sections of the pipe are arranged alternately along the length of the pipe.

The length of the respective unbonded length sections may be equal or they may vary. For providing a simple production it is advantageous that the lengths of the respective unbonded length sections are substantially equal. Therefore, in an embodiment at least about half of the unbonded length sections of the pipe are substantially equal in length.

In an embodiment the lengths of unbonded length sections differ e.g. such that the unbonded length sections where the pipe is subjected to relatively high load and/or dynamic influences are shorter than unbonded length sections where the pipe is subjected to lower load and/or less dynamic influences.

It has further been found that the position of the holding length sections relatively to the pitch length of the elongate armor elements of the first tensile armor layer has a large influence on the flexibility of the pipe.

In an embodiment the total length of a holding length section and an adjacent unbonded length section is about N times the winding pitch length of the first tensile armor layer, where N is an integer from 1 to 25. Thereby the holding length sections will be positioned such that there will be about N times the pitch length of the elongate armor elements of the first tensile armor layer from mid holding length section to mid holding length section, where mid holding length section means the lengthwise middle of the holding length section.

In an embodiment the total length of a holding length section and an adjacent unbonded length section constitutes a length period and the pipe comprises a plurality of length periods each with a length of about N times the winding pitch length of the first tensile armor layer, where N for each period individually is an integer from 1 to 25. This means that the length period for one length of a holding length section and an adjacent unbonded length section can be equal to or different from the length period for a length of another holding length section and its adjacent unbonded length section but still such that the length periods will always in this embodiment be about N times the winding pitch length of the first tensile armor layer.

In an embodiment a plurality of the holding length sections are arranged equidistantly along the length of the pipe, preferably in a repeating pattern having a repeating period determined along the length of the pipe from mid holding length section to mid holding length section.

In an embodiment the repeating period of the repeating pattern is at least about the pitch length of the first tensile armor layer.

In an embodiment the length of the repeating period of the repeating pattern of the holding length sections is from about the pitch length of the first tensile armor layer to about 20 times the pitch length of the first tensile armor layer, such as up to about 5 times the pitch length of the first tensile armor layer.

In an embodiment the length of the repeating period of the repeating pattern of the holding length sections is about N times the pitch length of the first tensile armor, where N is an integer from 1 to 25.

All features of the invention including ranges and preferred ranges can be combined in various ways within the scope of the invention, unless there are specific reasons not to combine such features.

### DESCRIPTION OF DRAWINGS

The invention will be explained more fully below in connection with a preferred embodiment and with reference to the drawings in which:

FIG. 1 is a schematic side view of a flexible pipe of the invention.

FIG. 2 is a schematic side view of a variation of the flexible pipe shown in FIG. 1.

FIG. 3 is a schematic side view of another flexible pipe of the invention.

FIG. 4 is a schematic side view of an inner pipe structure with an elongate armor element of the first tensile armor layer.

FIG. 5a is a side view of a flexible pipe showing the outer protection layer.

FIG. 5b is a side view of another flexible pipe showing the outer protection layer.

FIG. 6 is a schematic cross-sectional view of a wall section of a flexible pipe of the invention. The cross-sectional view is seen in a cut in length direction of the pipe.

FIG. 7 is a schematic cross-sectional view of a wall section of another flexible pipe of the invention. The cross-sectional view is seen in a cut in length direction of the pipe.

FIG. 8 is a schematic cross-sectional view of a wall section of yet another flexible pipe of the invention. The cross-sectional view is seen in a cut in length direction of the pipe.

The figures are schematic and may be simplified for clarity. Throughout, the same reference numerals are used for identical or corresponding parts.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

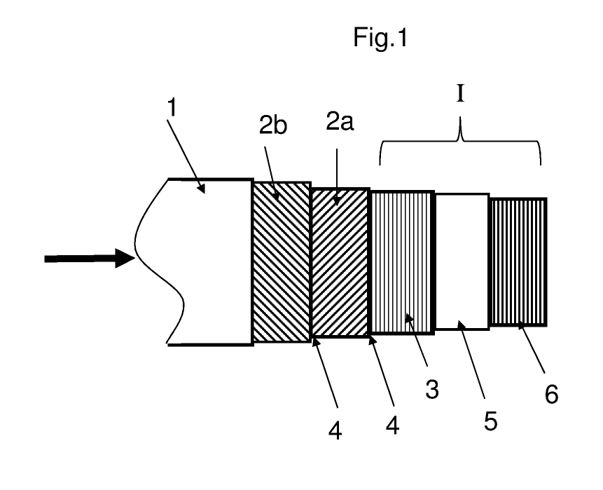

The flexible pipe shown in FIG. 1 comprises an inner pipe structure I comprising an innermost sealing sheath 5, e.g. of high density poly ethylene (HDPE), cross linked polyethylene (PEX), Polyvinyldifluorid (PVDF) or polyamide (PA). The innermost sealing sheath defines the bore of the pipe and has the purpose of preventing outflow of the fluid transferred in the bore of the pipe, indicated with the arrow. The inner pipe structure I further comprises an inner armor layer in form of a carcass 6 arranged inside the innermost sealing sheath 5. The carcass is normally made of metal, and has the main purpose of reinforcing the pipe against collapse as described above.

The flexible offshore pipe of the invention can also be provided without a carcass as described above. The carcass 6 is not liquid tight.

On the outer side of the innermost sealing sheath 5, the inner pipe structure I comprises a pressure armor layer 3, comprising helically wound armor element(s) of metal or composite material or combinations thereof, which is wound with an angle to the axis of the pipe of about 65 degrees or more, e.g. about 85 degrees. The pressure armor layer 3 is not liquid tight.

Outside the inner pipe structure I the flexible offshore pipe comprise the tensile armoring in form of a first and a second tensile armor layers 2a, 2b each comprising a plurality of helically wound elongate armor elements surrounding the inner pipe structure I.

The elongate armor elements on the first tensile armor layer 2a are wound with a winding degree of about 55 degrees or less to the axis of the pipe in a first winding direction and the second tensile armor layer 2b is wound with a winding degree of about 60 degrees or less, such as between about 20 and about 55 degrees to the axis of the pipe in a second winding direction, which is the opposite direction to the first winding direction i.e. the two tensile armor layers 2a, 2b are cross-wound. The pipe further comprises an outer protection sheath 1 which in the embodiment of FIG. 1 is a sealing sheath 1 protecting the armor layer mechanically and against ingress of sea water. As indicated with the reference number 4, the unbonded flexible pipe preferably comprises tape layers between the armor layers 3, 2a, 2b. The tape layers are usually not liquid tight and may for example be in the form of a wound film.

In not shown holding length sections at least one of the elongate armor elements of the first tensile armor layer 2a is fixed to, squeezed against and/or has a higher displacement friction to the inner pipe structure I than the elongate armor elements have in unbonded length sections of the pipe, thereby ensuring that the elongate armor elements of the first tensile armor layer are more restricted to displacement relative to the inner pipe structure I than the elongate armor elements of the first tensile armor layer in the unbonded length sections.

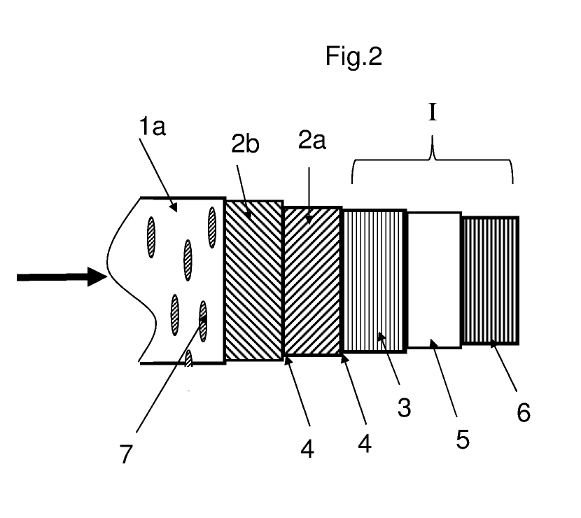

FIG. 2 shows a variation of the flexible pipe shown in FIG. 1 where the outer sealing sheath 1 has been replaced with an outer protecting and not sealing sheath 1a which is perforated 7 and non-liquid tight. The outer protecting sheath 1a provides a mechanical protection of the pipe.

The pipe of the invention may have more layers than the pipes of FIGS. 1 and 2. For example the pipe may comprise additional polymer layer or layers—often called intermediate sealing sheath. Such additional polymer layer or layers may be applied between the respective armor layers. For example the pipe may comprise insulating layer or layers e.g. applied between the outermost tensile armor layer and the outer sheath. The type of layers and order of layers may e.g. be as described in documents GB 1 404 394, U.S. Pat. No. 3,311,133, U.S. Pat. No. 3,687,169, U.S. Pat. No. 3,858,616, U.S. Pat. No. 4,549,581, U.S. Pat. No. 4,706,713, U.S. Pat. No. 5,213,637, U.S. Pat. No. 5,407,744, U.S. Pat. No. 5,601,893, U.S. Pat. No. 5,645,109, U.S. Pat. No. 5,669,420, U.S. Pat. No. 5,730,188, U.S. Pat. No. 5,730,188, U.S. Pat. No. 5,813,439, U.S. Pat. No. 5,837,083, U.S. Pat. No. 5,922,149, U.S. Pat. No. 6,016,847, U.S. Pat. No. 6,065,501, U.S. Pat. No. 6,145,546, U.S. Pat. No. 6,192,941, U.S. Pat. No. 6,253,793, U.S. Pat. No. 6,283,161, U.S. Pat. No. 6,291,079, U.S. Pat. No. 6,354,333, U.S. Pat. No. 6,382,681, U.S. Pat. No. 6,390,141, U.S. Pat. No. 6,408,891, U.S. Pat. No. 6,415,825, U.S. Pat. No. 6,454,897, U.S. Pat. No. 6,516,833, U.S. Pat. No. 6,668,867, U.S. Pat. No. 6,691,743, U.S. Pat. No. 6,739,355 U.S. Pat. No. 6,840,286, U.S. Pat. No. 6,889,717, U.S. Pat. No. 6,889,718, U.S. Pat. No. 6,904,939, U.S. Pat. No. 6,978,806, U.S. Pat. No. 6,981,526, U.S. Pat. No. 7,032,623, U.S. Pat. No. 7,311,123, U.S. Pat. No. 7,487,803, U.S. Pat. No. 2,310,2044, WO 28025893, WO 2009024156, WO 2008077410 and/or WO 2008077409, as well as in Specification for Unbonded Flexible Pipe, API, 17J, Third edition, July 2008 and/or in Recommended Practice for Flexible Pipe, API, 17B, Fourth edition, July 2008, provided that at least one armor layer is a displacement reduced armor layer as described herein.

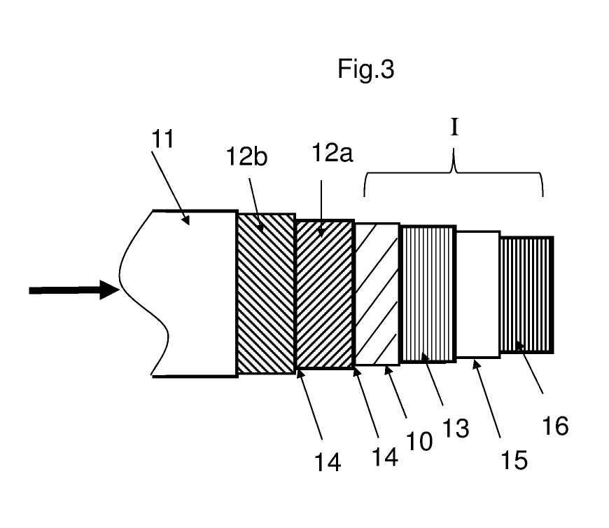

The flexible pipe shown in FIG. 3 comprises an inner pipe structure I comprising from inside and out a carcass 16, an innermost sealing sheath 15, a pressure armor layer a 13 and an insulating layer 10. Outside the insulating layer 10 the offshore pipe comprises the tensile armoring in form of a first and a second tensile armor layer 12a, 12b each comprising a plurality of helically wound elongate armor elements surrounding the inner pipe structure I. Outside the tensile armor layers 12a, 12b, the pipe comprises an outer protecting sheath 11. The individually layers may be as described above. The insulating layer 10 is advantageously a wound, liquid pervious layer e.g. as described in WO 2013/044920.

In not shown holding length sections at least one of the elongate armor elements of the first tensile armor layer 12a is fixed to, squeezed against and/or or has a higher displacement friction to the inner pipe structure I than the elongate armor elements of the first tensile armor layer in unbonded length sections. Advantageously the elongate armor elements of the first and optionally the second tensile armor layer are fixed to the insulation layer 10 with an additional lashing to the pressure armor layer 13 in the holding length sections.

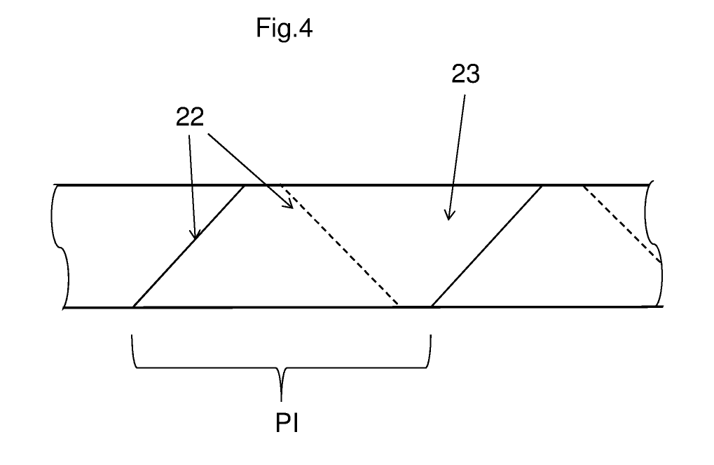

FIG. 4 shows the outer surface 23 of an inner pipe structure of an offshore pipe where only one elongate armor element 22 of the first tensile armor layer is seen. The elongate armor element 22 is helically wound around the outer surface 23 of the inner pipe structure. The dotted line indicates where the elongate armor element 22 is on the not-visible side of the inner pipe structure. As it can be seen the elongate armor element and thereby the first tensile armor layer has a pitch length PI.

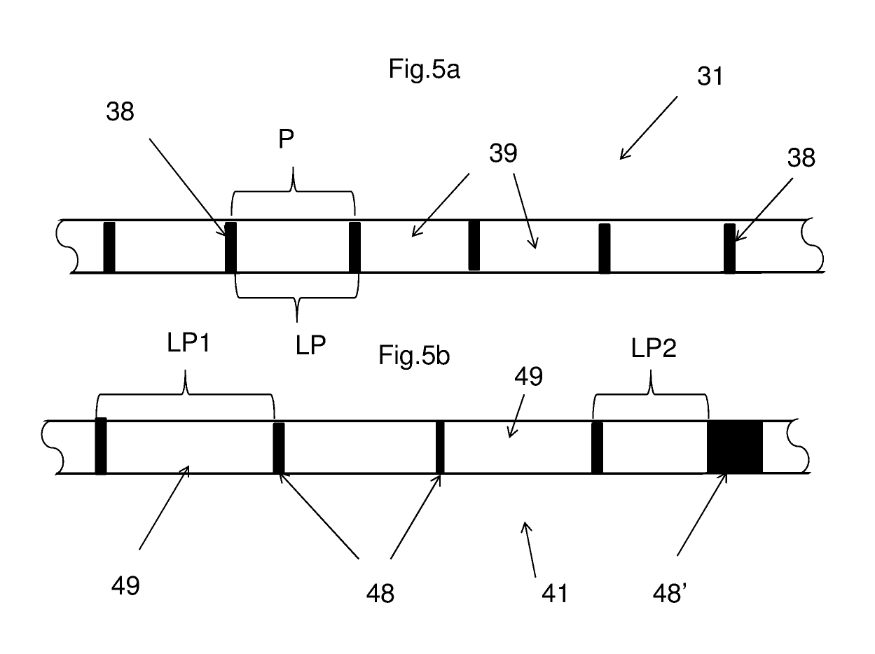

FIG. 5a shows an offshore pipe of the invention where only the outer protection layer 31 is seen. The outer protection layers comprise markings indicating the position and length of the holding length sections 38. The markings can be in form of annular clamping structures. As it can be seen the holding length sections 38 are much shorter than the unbonded length sections 39 adjacent to the holding length sections. The total length of a holding length section 38 and an adjacent unbonded length section 39 constitute a length period LP. In the embodiment shown in FIG. 5 the plurality of the holding length sections 38 are arranged equidistantly along the length of the pipe in a repeating pattern having a repeating length period LP as well as a repeating period P determined along the length of the pipe from mid holding length section to mid holding length section. Although not shown the repeating period P is N times PI, where N is an integer from 1 to 25.

FIG. 5b shows another offshore pipe of the invention where only the outer protection layer 41 is seen. The outer protection layers comprise markings indicating the position and length of the holding length sections 48. The markings can be in form of annular clamping structures. The holding length sections 48 are much shorter than the unbonded length sections 49 adjacent to the holding length sections. The length of the holding length sections 48, 48′ differs as do the lengths of the adjacent unbonded length sections 49.

It may for example be advantageous to make some of the holding length sections 48′ longer than other of the holding length sections 48 such that the longer holding length sections 48′ can be used as gripping areas when the pipe is deployed. Also it may be advantageous to have a longer length period LP1 in a part of the pipe and a shorter length period LP2 in another part of the pipe where the pipe is expected to be subjected to higher load.

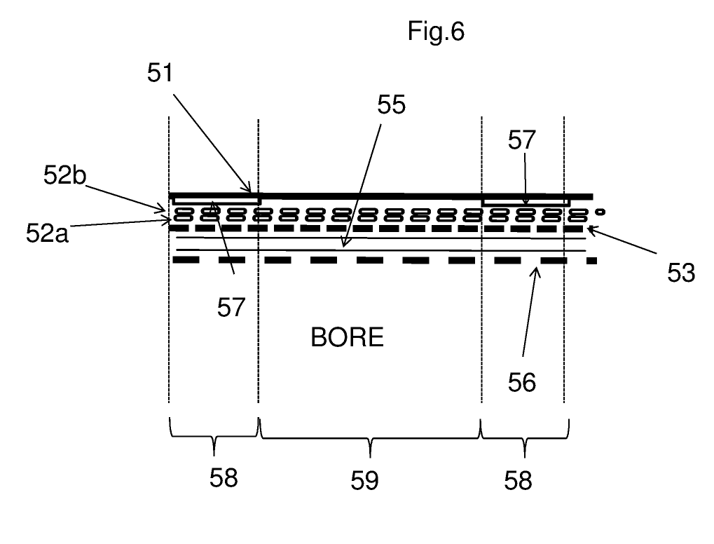

FIG. 6 shows the layers of an offshore pipe of the invention. The inner pipe structure comprises from inside and out a carcass, 56, an innermost sealing sheath 55, and a pressure armor layer 53. Outside the inner pipe structure the pipe comprises a first tensile armor layer 52a, a second tensile armor layer 52b and an outer protection layer 51. None of the layers 56, 55, 53, 52a, 52b, 51 are bonded to each other. The pipe has holding length sections 58 and unbonded length sections 59. In each holding length section 58 the pipe comprises an annular clamping structure 57 arranged to press the tensile armor layers 52a, 52b against the inner pipe structure. The annular clamping structures 57 are advantageously arranged inside the outer protecting layer such that the outer protection layer also protects these annular clamping structures 57. The outer protection layer 51 advantageously comprises markings indicating the position of the holding length sections 58.

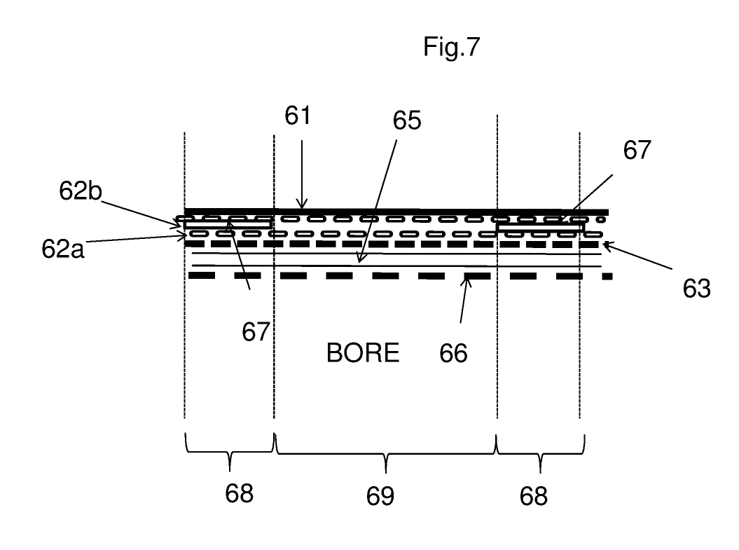

FIG. 7 shows the layers of an offshore pipe of the invention. The inner pipe structure comprises from inside and out a carcass, 66, an innermost sealing sheath 65, and a pressure armor layer 63. Outside the inner pipe structure the pipe comprises a first tensile armor layer 52a, a second tensile armor layer 62b and an outer protection layer 61. The pipe has holding length sections 68 and unbonded length sections 69. In each holding length section 68 the pipe comprises an annular clamping structure 67 arranged between the tensile armor layers 62a, 62b to press the first tensile armor layer 62a against the inner pipe structure.

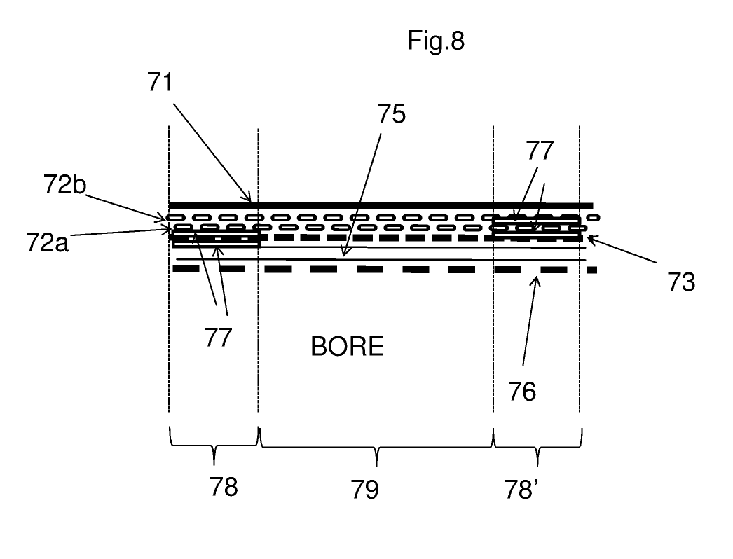

FIG. 8 shows the layers of an offshore pipe of the invention. The inner pipe structure comprises from inside and out a carcass, 76, an innermost sealing sheath 75, and a pressure armor layer 73. Outside the inner pipe structure the pipe comprises a first tensile armor layer 72a, a second tensile armor layer 52b and an outer protection layer 51. None of the layers 76, 75, 73, 72a, 72b, 71 are bonded to each other. The pipe has holding length sections 78, 78′ and unbonded length sections 79. In each of the holding length sections 78, 78′ the pipe comprises fixing material 77 arranged to fix one or more elongate armor elements of the first tensile armor layer 72a to the innermost sealing sheath. The fixing could for example be as in the holding section 78 where fixing material 77 is arranged between the first tensile armor layer 72a and the pressure armor layer 73 as well as between the pressure armor layer 73 and the innermost sealing sheath 75 or as shown in the holding section 78′ where fixing material 77 is arranged between the first tensile armor layer 72a and the pressure armor layer 73 as well as between the first and the second tensile armor layers 72a, 72b or a combination thereof.

What is claimed is:

1-42. (canceled)

43. A flexible offshore pipe suitable for transportation of fluids, the pipe comprises a plurality of layers comprising an inner pipe structure comprising an innermost sealing sheath defining a bore and a center axis defining a length of the pipe and a first and a second tensile armor layer each comprising a plurality of helically wound elongate armor elements surrounding the inner pipe structure, said first and said second tensile armor layer each has a winding pitch length and are cross wound with respect to each other, said pipe comprises a plurality of unbonded length sections and a plurality of holding length sections, wherein the elongate armor elements of the first tensile armor layer in said unbonded length sections are unbonded to said inner pipe structure and in each holding length section at least one of the elongate armor elements of the first tensile armor layer is more restricted to displacement relative to said inner pipe structure than the elongate armor elements of the first tensile armor layer in the unbonded length sections and where the total length of a holding length section and an adjacent unbonded length section is at least about the winding pitch length of the first tensile armor layer.

44. The flexible pipe of claim 43, wherein the at least one elongate armor element of the first tensile armor layer in each holding section of the pipe is fixed to, squeezed against and/or has a higher displacement friction to said inner pipe structure than the elongate armor elements have in said unbonded length section.

45. The flexible pipe of claim 43, wherein the at least one elongate armor element of the first tensile armor layer in at least one, such as in each holding length section of the pipe is fixed to the inner pipe structure, the fixing in a holding length section is provided by a fixing material, by a welding and/or a chemical bonding.

46. The flexible pipe of claim 43, wherein a plurality, such as all of the elongate armor elements of the first tensile armor layer in at least one, in each holding length section of the pipe is fixed to the inner pipe structure, the fixing is provided by arranging a fixing material between the first tensile armor layer and the inner pipe structure in said holding length section.

47. The flexible pipe of claim 43, wherein the at least one elongate armor element of the first tensile armor layer in at least one, such as in each holding section of the pipe is squeezed against said inner pipe structure, said at least one elongate armor element of the first tensile armor layer is preferably squeezed against said inner pipe structure by applying a squeezing pressure against the first tensile armor layer in said holding length section.

48. The flexible pipe of claim 43, wherein the at least one elongate armor element of the first tensile armor layer in at least one, such as in each holding length section of the pipe has a higher displacement friction to said inner pipe structure than the elongate armor elements have in said unbonded length sections of the pipe.

49. The flexible pipe of claim 48, wherein the higher displacement friction is caused by providing a friction element between the first tensile armor layer in the holding length section, the friction element is of a polymer material, such as a polymer material having a hardness which is less than an outermost surface hardness of inner pipe structure, the friction element is of a polymer material having a hardness of 90 Shore A or less, such as a rubber material.

50. The flexible pipe of claim 43, wherein the inner pipe structure has an outermost layer provided by a sealing sheath having a thickness of at least about 4 mm, the at least one elongate armor element of the first tensile armor layer in at least one, such as in each holding section of the pipe is fixed to, squeezed against and/or or has a higher displacement friction to said outermost layer of the inner pipe structure than the elongate armor elements have in said unbonded length sections of the pipe, said sealing sheath is the innermost sealing sheath or an intermediate sealing sheath.

51. The flexible pipe of claim 43, wherein the inner pipe structure has an outermost layer provided by a tape, such as an anti-wear tape and a strength imparting layer below the tape, the at least one elongate armor element of the first tensile armor layer in at least one, such as in each holding section of the pipe is fixed to, squeezed against and/or or has a higher displacement friction to said strength imparting layer of the inner pipe structure than the elongate armor elements have in said unbonded length sections of the pipe.

52. The flexible pipe of claim 43, wherein the inner pipe structure comprises a pressure armor layer arranged outside the innermost sealing sheath, the pressure armor layer comprises at least one helically wound elongate armor elements, wound with a winding degree relative to the center axis of about 70° or more, such as about 80° or more.

53. The flexible pipe of claim 43, wherein the elongate armor elements of the tensile armor layers are wound with an angle to the center axis of from about 20° to about 70°, such as from about 30° to about 60°, such as from about 35° to about 55°.

54. The flexible pipe of claim 43, wherein the elongate armor elements of the second tensile armor layer in said unbonded length sections are unbonded to said inner pipe structure and said first tensile armor layer and in each holding length section the elongate armor elements of the second tensile armor layer is fixed to or squeezed against the first tensile armor layer.

55. The flexible pipe of claim 43, wherein the average length of the holding length sections is shorter than the average length of the unbonded length sections.

56. The flexible pipe of claim 43, wherein the length of the holding length sections is up to about 2 m, such as from about ½ cm to about 1 m, such as from about 1 cm to about 0.5 m.

57. The flexible pipe of claim 43, wherein the total length of a holding length section and an adjacent unbonded length section is about N times the winding pitch length of the first tensile armor layer, where N is an integer from 1 to 25.

58. The flexible pipe of claim 43, wherein the total length of a holding length section and an adjacent unbonded length section constitutes a length period and the pipe comprises a plurality of length periods each with a length of about N times the winding pitch length of the first tensile armor layer, where N for each period individually is an integer from 1 to 25.

59. The flexible pipe of claim 43, wherein a plurality of the holding length sections are arranged equidistant along the length of the pipe, in a repeating pattern having a repeating period determined along the length of the pipe from mid holding length section to mid holding length section.

60. The flexible pipe of claim 43, wherein the repeating period of the repeating pattern is at least about the pitch length of the first tensile armor layer.

61. The flexible pipe of claim 43, wherein the length of the repeating period of the repeating pattern of the holding length sections is from about the pitch length of the first tensile armor layer to about 20 times the pitch length of the first tensile armor layer, such as up to about 5 times the pitch length of the first tensile armor layer.

62. The flexible pipe of claim 1, wherein the length of the repeating period of the repeating pattern of the holding length sections is about N times the pitch length of the first tensile armor, where N is an integer from 1 to 25.
